(19) United States
(12) Patent Application Publication
(10) Pub. No.: US 2015/0189365 A1
(43) Pub. Date: Jul. 2, 2015

(54) METHOD AND APPARATUS FOR GENERATING A RECORDING INDEX

(71) Applicant: THOMSON LICENSING, Issy de Moulineaux (FR)

(72) Inventors: Minqing XING, Fishers, IN (US); Mohammmad AFANEH, Noblesville, IN (US)

(21) Appl. No.: 14/140,805

(22) Filed: Dec. 26, 2013

(51) Int. Cl. H04N 21/435; H04N 21/44; H04N 21/462; H04N 21/434

(52) U.S. Cl. CPC H04N 21/435; H04N 21/4343; H04N 21/4348; H04N 21/44004; H04N 21/4622

(57) ABSTRACT

An apparatus and method for indexing data streams and generating an index file used during trick mode playback makes use of a demultiplexer that receives content formatted as a transport stream including a plurality of transport packets from a source. For each of the plurality of transport packets generates, the demultiplexer generates flag data indicating if the respective transport packet contains key frame data. A buffer includes at least one sub-buffer for storing the flag data and key frame data. An index processor parses the at least one sub-buffer to locate the flag data and uses the flag data to generate an index file including a position of each key frame in the transport stream to facilitate trick mode playback of the transport stream.

### FIELD OF THE INVENTION

The present principles relate to processing data streams and more specifically, to generating a hardware independent mechanism for indexing a data stream.

### BACKGROUND OF THE INVENTION

The number of cable and satellite television providers has increased through the years along with their ability to deliver content to subscribing users. Many advancements have contributed to this rise, but none more so than the advances in encoding/decoding of raw content for delivery to users. Additionally, due to improved encoding/decoding methods, the ability of a consumer to consume multiple pieces of content has also increased. It is commonplace for a set top box (STB) to include at least two different tuners that allow users to tune in and view one program while recording at least one other program at the same time. This digital video recording (DVR) technology has changed the way users interact with the content they wish to consume because it allows the user to be able to time shift when they are going to consume the content as well as store the content for later and/or repeated use. DVR's also provide the user with ability to fast forward and rewind stored content. Typically, this is referred to as “trick mode” and allows the user to play back the content stream at different speeds (e.g. 1×, 2×, 4×, 8×, etc).

In some instances, trick mode can be realized by setting the video pipeline to decode and render the video stream at a faster or slower speed/rate than the normal playback rate. However, due to limited processing power of a system, and to realize faster speeds (either forward or reverse) in trick mode, some of the frames of the encoded content stream need to be skipped. This is accomplished by indexing frames in the content stream that can be decoded independently (e.g. key frames). A drawback associated with this indexing process is that each manufacturer of decoding equipment generally implements its own indexing process which is tied directly to its own hardware implementation. Therefore, a need exists to provide an indexing module that is hardware independent and can be easily ported to different platforms.

### SUMMARY OF THE INVENTION

Embodiments of the present principles address the deficiencies of the prior art by providing a method and apparatus for indexing data streams that are hardware independent and can be easily ported to different platforms.

In one embodiment of the present principles, an apparatus for generating an index file used during trick mode playback includes a demultiplexer which receives content formatted as a transport stream including a plurality of transport packets from a source. For each of the plurality of transport packets the demultiplexer generates flag data if the respective transport packet contains key frame data. The apparatus further includes a buffer which includes at least one sub-buffer for storing the flag data and key frame data and an index processor which parses the at least one sub-buffer to locate the flag data and uses the flag data to generate an index file including a position of each key frame in the transport stream to facilitate trick mode playback of the transport stream.

In an alternate embodiment of the present principles, a method of generating an index file used during trick mode playback includes receiving, by a demultiplexer, content formatted as a transport stream including a plurality of transport packets from a source, generating, for each of the plurality of transport packets, flag data if the respective transport packet contains key frame data and storing flag data and key frame data in at least one sub-buffer of a buffer. The method can further include parsing, by an index processor, the at least one sub-buffer to locate the flag data and using the flag data to generate an index file including a position of each key frame in the transport stream to facilitate trick mode playback of the transport stream.

### BRIEF DESCRIPTION OF THE DRAWINGS

The teachings of the present principles can be readily understood by considering the following detailed description in conjunction with the accompanying drawings, in which:

FIG. 1 depicts a high level block diagram of an apparatus for indexing data streams in accordance with an embodiment of the present principles;

FIG. 2 depicts an illustrative view of a transport stream processed and indexed by the apparatus of FIG. 1 in accordance with an embodiment of the present principles;

FIG. 3 depicts a high level block diagram of an embodiment of a sub-buffer of a buffer of the apparatus of FIG. 1 in accordance with an embodiment of the present principles;

FIG. 4A depicts exemplary content of a buffer of an apparatus in accordance with an embodiment of the present principles;

FIG. 4B depicts exemplary content of a buffer of the apparatus in accordance with an embodiment of the present principles;

FIG. 4C depicts exemplary content of a buffer of the apparatus in accordance with an embodiment of the present principles;

FIG. 5 depicts a flow diagram of a method for indexing data streams in accordance with an embodiment of the present principles; and

FIG. 6 depicts a flow diagram of a method for generating an index file which can be implemented in the method of FIG. 5 in accordance with an embodiment of the present principles.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present principles advantageously provides a method and apparatus for indexing data streams and generating an index file associated with a transport stream which are usable to facilitate trick mode playback of the transport stream. Although the present principles will be described primarily with reference to a set-top box apparatus and transport data streams, the specific embodiments should not be treated as limiting the scope of the invention. It will be appreciated by those skilled in the art and informed by the teachings of the present principles that the principles of the invention can be advantageously applied to any device which has the ability to receive transport stream data and or output a pre-recorded transport stream on a display device either embodied therein or connected thereto and can be applied to any content stream including packets.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

Embodiments of the present principles provide a novel method and apparatus for indexing a transport stream containing audio-video data. The method can be implemented in any type of hardware apparatus capable of receiving and decoding encoded content data streams for display. Such apparatuses can include, but are not limited to, set-top boxes, personal computers, laptops, portable computing devices, tablets and smartphones. In accordance with various embodiments of the present principles, encoded transport stream are indexed to enable an apparatus to implement trick mode playback (e.g. fast forward or fast rewind) of a transport stream by providing the apparatus with a set of quick reference points within the transport stream that point to portions therein that are independently decodable by the decoding circuitry or other decoding module. As used herein, the term transport stream refers to a particular type of data stream that is encoded in a particular type of data format that comprises at least one independently decodable frame (e.g. key frame) and subsequent non-independently decodable frames (e.g. delta frames). In addition, content, as used herein, includes any type of audio visual data, either in encoded or un-encoded form.

Embodiments of the present principles provide a common data structure which hides platform-specific details when generating an index of the independently decodable portions of the transport stream. By hiding the platform-specific details in accordance with the present principles, the indexing of the present principles can be implemented on any type of apparatus able to receive and decode an encoded transport stream. In embodiments of the present principles, a demultiplexer (hereinafter, the “demux”) is provided and parses to identify independently decodable frames and non-independently decodable frames. All independently decodable frames identified by the demux are divided from the transport stream into sub-buffers and are marked using flags. As used herein the term buffer and/or sub-buffer may include at least one of (a) a dedicated partitionable storage medium for temporarily storing transport stream data; (b) at least one file saved on a storage medium, the file representing the key and delta frames of a transport stream data; (c) any other type of organizable storage mechanism that enables key frames and delta frames to be stored therein and indexed using the flag data generated by the demux. The flags are generated by the demux and are structured according to a common indexing data structure thereby identifying respective start and end positions of each of the independently decodable frame in respective sub-buffers. It should be noted that an independently decodable frame may span a plurality of sub-buffers depending on the size (in bytes) thereof as well as the size (in bytes) of the sub-buffers of the apparatus. Thus, the flags also advantageously identify whether or not a portion of the independently decodable frame is either a start point or end point thereof. Upon setting the flags for each independently decodable frame, an index processor, which includes a segmenter, generates an index file associated with the transport stream using the flag data. The segmenter also records the transport stream to the respective buffers for later access, retrieval and decoding for playback. In embodiments of the present principles, upon an event indicating that data is available on the respective index port, the index data is read and put on a queue and read from the queue as needed while the transport stream is being processed.

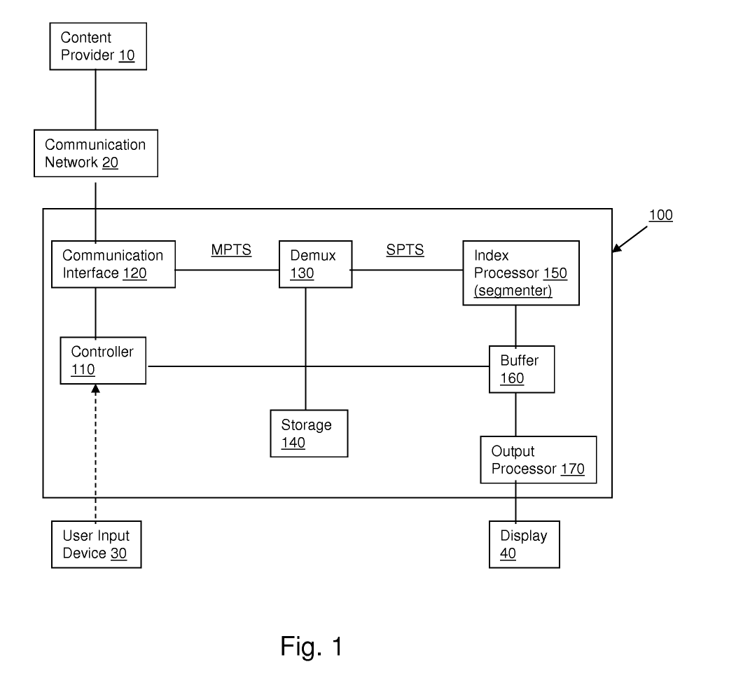

FIG. 1 depicts a high level block diagram of an apparatus 100 for indexing and processing transport streams in accordance with an embodiment of the present principles. The apparatus 100 of FIG. 1 illustratively includes a controller 110 for governing the operation of the apparatus 100. In various embodiments of the present principles, the controller 110 executes algorithms for acquiring, processing and outputting content data contained in a transport stream to a user. In one embodiment, the apparatus 100 can comprise a set top box such as commonly provided by a cable or satellite provider and which is disposed at a particular user's location to allow a user to selectively consume audio-video content data via a display screen. In an alternate embodiment of the present principles, the apparatus can comprise a portable digital television device that allows a user to wirelessly consume audio-video content. In a further embodiment of the present principles, the apparatus 100 can be embodied in a smartphone or tablet computing device that also allows a user to consume audio-video content. These embodiments are described for purposes of example only and any apparatus able to receive encoded streams of audio video content data can be used to implement the inventive concepts of the present principles.

The apparatus 100 of FIG. 1 further comprises a communication interface 120 in communication with the controller 110. In one embodiment of the present principles, the controller 110 can process a content acquisition request, such as a request from a user, that directs the communication interface 120 to receive and process data including audio-video content streaming from a content provider 10 via a communication network 20. The content provider 10 can include any source of encoded audio video content that can be provided to a user. The communication network 20 can include any type of network able to transmit audio-video data streams to the apparatus 100. This includes but is not limited to, a cable network, satellite network, IP-based network and/or cellular networks. The communication network 20 can also comprise any combination of wired and wireless networks as is known in the art.

In one embodiment, the content acquisition request can be a request from a user to select a particular television program from their cable/satellite provider. In an alternate embodiment, the content acquisition request can include a request for a stream of content data from a streaming content provider (e.g. NETFLIX®). These particular content acquisition requests are described for purposes of example only and any such request that allows the apparatus to obtain content can be implemented in accordance with the principles of the embodiments of the present invention. Moreover, the particular aspects of acquiring content are known in the art and are not germane to the present indexing method of the embodiments of the present principles and need not be further discussed.

In one embodiment of the present principles, the communication interface 120 receives content data in the form of a multiple program transport stream (MPTS) which includes a plurality of individual transport streams, each corresponding to a respective program that is encoded according to a particular encoding format such as MPEG or H264. The apparatus 100 of FIG. 1 further includes a demultiplexer (demux) 130 in communication with the communication interface 120 and the controller 110. The MPTS received by the communication interface 120 is provided to the demux 130 for processing into a single program transport stream (SPTS) against which an index of independently decodable frames will be generated in accordance with various embodiments of the present principles. In the embodiment of FIG. 1, the demux 130 is controlled by the controller 110 to demultiplex the MPTS to select a particular transport stream from the MPTS which corresponds to a particular SPTS containing a desired program. Upon selection of the SPTS by the demux 130, the SPTS is either processed, in real time, to generate an index file for use in trick mode using the indexing methods according to invention principles or, stored on a storage medium 140 for later retrieval thereof. Regardless of which processing pathway selected at a given time, the indexing method according to the invention principles operates in a similar manner whether the decoding and output of the SPTS occurs in real time or whether the SPTS is being recalled from the storage medium 140 of FIG. 1 after being stored thereon. Thus, the following description of the components and modules that implement the indexing method according to invention principles equally apply to pre-recorded SPTS or on-the-fly decoding SPTS.

The components and modules used in executing an embodiment of the indexing method of the present principles for a particular SPTS will now be discussed. The indexing method according to an embodiment of the present principles is implemented via the demux 130, an index processor 150 and a buffer 160 for storing SPTS data and the corresponding index data therein. In accordance with an embodiment of the present principles, the index processor 150 is in communication with the demux 130 and the buffer 160 and can comprise a segmenter that splits the SPTS output by the demux 130 into respective segments for storage in respective sub-buffers of the buffer 160 of FIG. 1. The index processor 150 also generates an index file that is useable by the controller 110 in response to a user engaging a trick mode functionality of the apparatus 100 to create at least one of fast forward or fast rewind content in the particular SPTS being decoded and displaying the created content to a user.

In the embodiment of FIG. 1, the controller 110 causes an SPTS to be output by the demux 130. The controller 110 further causes the demux 130 to parse the SPTS to identify the individual frames that form the SPTS to determine whether they are independently decodable frames (e.g. key frames) or non-independently decodable frames (e.g. delta frames) for use in generating a common indexing structure. Although the description of the embodiments of the present principles reference key frames and delta frames, such language is for purposes of example only. Such types of independently and non-independently decodable frames correspond to encoding formats such as MPEG and H264 however, the indexing according to embodiments of the present principles are not so limited and can be applied to any SPTS that is encoded in any format as long as the encoding format includes at least one independently decodable frame and at least one non-independently decodable frame downstream therefrom.

Referring back to FIG. 1, as the demux 130 obtains the SPTS and SPTS-specific index data, the demux 130 splits the SPTS into sub-buffers based on index information setting flags (i.e., key frame or delta frame indicator, start/end offset in case of key frames, etc.) and communicates them to the index processor/segmenter 150. It should be noted that in various embodiments of the present principles, each sub-buffer contains either key frame or delta frame data, but not both. Additionally, the SPTS-specific index data is different from the index file generated by the index processor/segmenter 150. That is, in accordance with embodiments of the present principles, if the demux 130 determines that the sub-buffer includes key frame data, the demux 130 sets the flag data identifying the sub-buffer as a key frame. In doing so, the demux 130 determines the start and end offset in bytes of the key frame, and identifies a number of sub-buffers in which the key frame data needs to be stored for processing. The flag data set by the demux 130 advantageously enables key frames to be split across multiple sub-buffers and still enables an index file identifying the position of the key frame within the SPTS to be generated. If the demux 130 determines that the sub-buffer does not include any key frame data, the demux 130 sets a value of a flag indicating that the respective sub-buffer includes a delta frame and any sub-buffer indicated as such will not be used in generating the index file and instead will just be written to the respective buffer for later decoding and/or other processing. The decision by the demux 130 as to the number of sub-buffers needed to store particular key frame or delta frame data can be dependent on the SPTS data available at the moment the SPTS data is being processed. For example, in one embodiment of the present principles, the demux 130 can determine that only a portion of a key frame is present in the current available SPTS data. Instead of waiting for the whole key frame to be available, the demux 130 can create a sub-buffer for this partial key frame only and subsequent key frame data can be stored in additional sub-buffers as the data becomes available. In such embodiments of the present principles, the demux 130 generates a flag data to indicate such storage.

The flag data of the common indexing structure of various embodiments of the present principles includes at least a first flag field associated with a start position of a particular independently decodable frame and a second flag field associated with an end position of the particular independently decodable frame. The values in each of the first flag field and second flag field are used to identify a characteristic of the independently decodable frame in a respective sub-buffer and can include information regarding at least one of (a) a start position; (b) and end position; and (c) neither start nor end (e.g. None). The flag data and flag data fields will be discussed in greater detail with respect to FIG. 3 below.

In accordance with embodiments of the present principles, the flag fields advantageously provide a common structure that identifies the position of a respective key frame within an SPTS based on its offset position relative to the header or starting point of the entire SPTS along with the packet number associated with the particular key frame being processed at that time.

Referring back to FIG. 1, once the key frame has been flagged, the index processor 150 directs the key frame and the flag data associated therewith to be stored in a respective sub-buffer of buffer 160. The index processor 150 parses all sub-buffers of buffer 160 to identify flag data associated with all key frames and generates an SPTS-specific index file using the flag data. The SPTS-specific index file can be stored on the storage medium 140 for later access by the controller 110 in response to receiving a control signal from a user input device 30 (e.g. remote control, smartphone application, tablet application, etc) that initiates trick mode playback for the particular SPTS.

Table 1, below, depicts an exemplary SPTS-specific index file generated according to an embodiment of the present principles. Table 1 further includes information describing the values stored in each respective field of the index file which appear after the “//” in each line thereof.

TABLE 1
Sample Index File Structure

typedef struct_tech_index_data

| | | |
|---|---|---|
| { | | |
| uint32_t | timestamp; | //value in millisecond |
| | | //allowing for ~50days of recording |
| uint32_t | start_offset; | //value relates to the start offset |
| | | of the key frame in bytes |
| | | // from the first transport..packet |
| | | in the current segment |
| uint32_t | size | // value in bytes representing the |
| | | size of the key frame |
| uint32_t | aux_data | //reserved |
| | | for extensions |
| } Tech_index_data; | | |

As show in Table 1, the index file includes a single record corresponding to a single key frame. Thus, in application, the index file will include a plurality of records each associated with the plurality of key frames contained in the SPTS. The records in the embodiment of the invention depicted in Table 1 advantageously provide timestamp information as well as offset information describing a number of bytes that the particular key frame associated with the particular record is offset from the first transport packet in the SPTS. The record further includes size information identifying a size of the key frame associated with the record thus enabling the system to know the number of buffers in which the key frame data is stored. In various embodiments of the present principles, the index file can also include an auxiliary data field that is capable of storing any additional data relevant to the transport stream associated with the index file.

In accordance with embodiments of the present principles, the controller 110 identifies the SPTS to be decoded (e.g. real-time decoding or previously recorded and retrieved from the storage medium 140) depending on the parameters of the control signal received from the user input device 30 and outputs a display to a display device 40 via an output processor 170 of the apparatus. The output processor 170 of FIG. 1 include all circuits and components that are used to decode the SPTS to be in a format suitable for display on the display device 40. The display device 40 can include but is not limited to (a) a television; (b) a monitor; (c) a computer; (d) a tablet computing device; or (e) a smartphone.

In the embodiment of FIG. 1, the controller 110 accesses the SPTS-specific index file stored on the storage medium 140 and uses the key frame position information in the index file to facilitate a requested trick mode playback. For example, if the requested trick mode playback is a fast forward, the controller 110 identifies a current position of the SPTS and parses the SPTS-specific index file to identify a subsequently occurring key frame and causes those key frames to be output by the output processor 170. In contrast, if the requested trick mode playback is a fast rewind, the controller 110 identifies key frames in the SPTS-specific index file positioned earlier in time and causes those key frames to be output by the output processor 170. By using a commonly structured SPTS-specific index file in accordance with embodiments of the present principles, the controller 110 can adapt and implement all aspects of trick mode playback including increased speeds for each playback mode because the controller 110 can easily determine, from the index file, the position of the key frames that need to be skipped when increasing fast forward or fast rewind speeds while maintaining the ability of the controller 110 to ensure that the correct key frame is being output at the correct time.

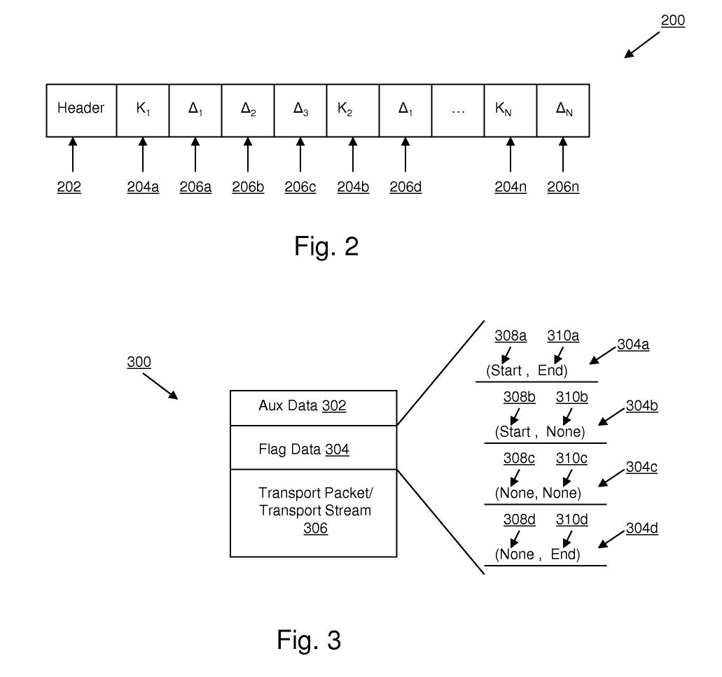

FIG. 2 depicts an illustrative view of a transport stream processed and indexed by the apparatus 100 of FIG. 1 using an indexing method in accordance with an embodiment of the present principles. In FIG. 2, the SPTS stream 200 includes a header 202 that includes information describing the stream parameters, size, format and structure. Following the header 202 is a first key frame (K₁) 204a which represents an independently decodable frame to be included in an index file. The first key frame (K₁) 204a, is followed by three delta frames 206a-206c (Δ₁-Δ₃). In FIG. 2, a second key frame (K₂) 204b follows delta frame 206c and is itself followed by a delta frame 206d (Δ₄). In FIG. 2, the SPTS stream 200 continues to include any number of key frames (K_{N}) with each key frame being followed by at least one delta frame (Δ_{N}), where N is a positive integer. The format and structure of the SPTS stream 200 is shown for purposes of example only and in alternate embodiments of the present principles, depending on the method of encoding and the encoding format, the number of key frames and ratio of delta frames to each key frame can change.

The SPTS stream 200 of FIG. 2 is, for illustrative purposes, to be considered the stream output by demux 130 in FIG. 1 which is received and parsed by the index processor 150. In operation, the demux 130 parses the stream and uses information in the header 202 to identify certain characteristics of the SPTS stream 200. In various embodiments of the present principles, the characteristics identified during this parsing can be considered auxiliary data. The auxiliary data includes at least one of (a) a number of transport packets in the stream; and (b) offset information identifying the point from the start of the SPTS stream 200 at which the frame is positioned. In various embodiments of the present principles, the characteristics of the SPTS stream 200 identified by the index processor 150 can also include at least one of (a) time stamp data; and (b) discontinuity data. Discontinuity data refers to information that enables the system to provide a smooth transition when a first file associated with a transport stream is at a first time and a second file associated with the same transport stream has a second different time associated therewith. Discontinuity refers to a condition where the timestamp of a subsequent transport stream segment is outside a predefined window in time (i.e., the timestamp points to a time in the past or too far in the future relative to the current presentation time).

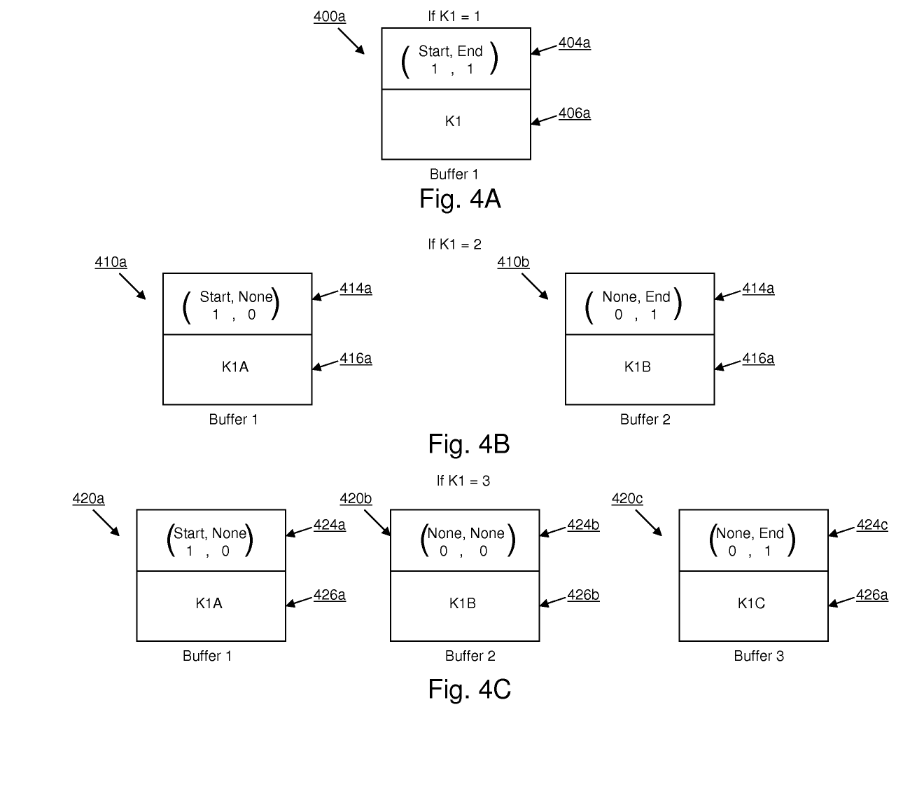

Referring back to FIGS. 1 and 2, the demux 130 sequentially parses the stream 200 and identifies the type of frame associated with each transport packet of the stream 200. The index processor sets flag data identifying that the frame is one of a key frame 204 or a delta frame 206 and writes the frame, as identified, to a sub-buffer as will be discussed in more detail with respect to FIGS. 3 and 4 below. In response to identifying that the frame associated with the transport packet is a key frame 204, the demux 130 determines a number of sub-buffers needed to store the identified key frame 204 and sets flag data indicating the start position and end position of the particularly identified key frame 204. In the event that the identified key frame spans more than one sub-buffer, the index processor 204 further sets flags indicating that a particular sub-buffer includes either the start position without an end position, an end position without a start position, or neither. By setting flag data as neither a start nor end position but positioned between a sub-buffer having a start indicator and another sub-buffer having an end indicator, it is understood that the data stored in the particular sub-buffer is a part of that key frame. This flag data is stored in the respective sub-buffer and is used by the index processor 150, along with the auxiliary data described above, to generate the index file associated with the particular transport stream 200.

FIG. 3 depicts a high level block diagram of an embodiment of a sub-buffer of the buffer 160 of the apparatus of FIG. 1 in accordance with an embodiment of the present principles. In the embodiment of FIG. 3, each sub-buffer 300 of the buffer 160 enables at least 3 types of data to be stored therein for processing. For example, in the embodiment of FIG. 3, in a first sub-buffer field 302, auxiliary data identified while the demux 130 is processing the SPTS stream 200 is stored in auxiliary data field 302. In the embodiment of FIG. 3, the data in auxiliary data field 302 corresponds to identified stream characteristics including at least one of (a) a number of transport packets in the stream; (b) offset information identifying the point from the start of the SPTS stream 200 at which the frame is positioned; (c) time stamp data; and (d) discontinuity data. Additionally in the embodiment of FIG. 3, the sub-buffer 300 includes a flag data field 304 that includes data representing the flags set by the demux 103 and which identifies a particular frame as a key frame or a delta frame. The flag data field further includes information identifying whether a particularly identified key frame is stored in the respective sub-buffer 300 or if the key frame is stored in more than one sub-buffer. The data values stored in flag data field 304 include a first sub-field associated with a start position for a respective key frame represented generally by reference numeral 308 and a sub-field associated with an end position of a respective key frame represented generally by reference numeral 310. In one embodiment of the present principles, the values set in each sub-field 308 and 310 are binary such that a first value (e.g. “1”) indicates that the field is true while a second different value (e.g. “0”) indicates that the field is false. The plurality of different types of flag data values that may be stored in flag data field 304 are represented as flag data values 304a-304d. Moreover, it is import to note that, in one embodiment of the present principles, start position values are provided relative to the offset data stored in auxiliary data field 302 to indicate the position of that key frame relative to the start position of the entire stream.

In the embodiment of FIG. 3, a first type of flag data value 304a indicates that sub-buffer 300 includes a complete key frame. This is indicated by a first sub-field including identification that a start position of the key frame is present and a second sub-field indicating that an end position is present. In binary representation, the first type of flag data value can be stored as “(1,1)”. In response to the index processor 150 parsing the sub-buffer 300, the index processor 150 advantageously understands that two “true” values in the flag data field 304 indicates that the data stored in sub-buffer 300 is a complete key frame and uses this data when generating the index file to indicate that a complete key frame is positioned at a particular point within the stream 200 relative to the start of the complete stream.

Alternatively and referring to the embodiment of FIG. 3, a second type of flag data 304b and third type of flag data 304c can be used to indicate that sub-buffer 300 includes an incomplete key frame and thus indicates that the particular key frame spans multiple sub-buffers. For example, if the incomplete key frame includes only the start position of the respective key frame, then the second type of flag data 304b is stored in flag data field 304. The second type of flag data 304b includes information indicating that a start position of the key frame is present but the end position of the key frame is not. In binary representation, the second type of flag data 304b can be stored as “(1,0)”. If the incomplete key frame includes only the end position thereof, then the third type of flag data 304c is stored. The third type of flag data 304c includes information indicating that no start position is present but that an end position is present. In binary representation, the third type of flag data can be stored as “(0,1)”.

A fourth type of flag data 304d that can be implemented in accordance with embodiments of the present principles can be used to identify at least one of that (a) the frame is a delta frame; and (b) the frame is a part of a key frame spanning multiple sub-buffers but does not contain either a start or end position. The data values of the fourth type of flag data 304d indicate that neither a start frame position nor an end frame position is present. In binary representation, the values of the fourth type of flag data can be stored as “(0,0)”. The fourth type of flag data 304d can advantageously be used by the index processor 150 when generating the index file to identify that the frame is a delta frame or is part of a key frame that spans multiple buffers by using the data stored therein relative to the flag data values stored in previous and subsequent sub-buffers. If the immediately previous sub-buffer also includes either the third type of flag data 304c or fourth type of flag data 304d stored in flag data field 304, the index processor 304 determines that the data stored in sub-buffer 300 is a delta frame and moves onto subsequent sub-buffers to identify the next key frame. If the previous sub-buffer includes the second type of flag data 304b, the index processor 304 determines that the data stored in sub-buffer 300 is part of a current key frame and the address, size and position of the sub-buffer are included by the index processor 150 in the index file of key frames.

In the embodiment of FIG. 1, the sub-buffer 300 includes a data section 306 in which transport stream data parsed by the demux 130 and flagged as discussed above can be stored. The data stored in data section 306 is used by the system for further processing, decoding and presentation. Additionally, if the data stored in data section 306 corresponds to a key frame or portions of a key frame, that data can be used by the apparatus 100 when trick mode playback is initiated to process one of the fast forward or fast rewind aspects of trick mode playback.

Examples of sub-buffers 300 that have key frames of different sizes are shown in FIGS. 4A-4C. For purposes of ease of understanding, the auxiliary data field of the sub-buffer is not shown but should be understood to be present. FIG. 4A depicts a sub-buffer 400a that includes a complete key frame (K1) stored in the data section 406a. As such, in the embodiment of the present principles of FIG. 4A the flag data stored in flag data field 404a is the first type of flag data described above wherein the first sub-field representing the start position is indicated as “true” and stored in binary as a “1” and the second sub-field is also indicated as “true” and stored in binary as “1”. The index processor 150, upon reading the data values in the flag data field appends the address of this key frame and its position relative to the start of the entire stream to the index file, thereby enabling this frame to be quickly located and used when trick mode playback is initiated by a user.

FIG. 4B depicts an embodiment of the present principles in which the demux 130 determines that a key frame, K1, =2. This means that the current key frame, based on the analysis of available space in a previous and current sub-buffer, is identified by the demux 130 as existing in two sub-buffers 410a and 410b. Thus, together, sub-buffers 410a and 410b include a complete key frame (K1) stored in the data section 416a and 416b, respectively. The demux 130, when parsing the stream, determines that this particular key frame has a size that requires it be partitioned into a first portion K1A for storage in a first sub-buffer 410a and a second portion K1B for storage in a second sub-buffer 410b. Because this key frame spans two sub-buffers 410a and 410b, the flag data stored in flag data field 414a of the first sub-buffer 410a is the second type of flag data described above wherein the first sub-field representing the start position is indicated as “true” and stored, in binary as a “1” and the second sub-field is indicated as “false” and stored, in binary as “0”. It then follows that the flag data stored in flag data field 414b is the third type of flag data described above wherein the first sub-field representing the start position is indicated as “false” and stored, in binary as a “0” and the second sub-field is indicated as “true” and stored, in binary as “1”. The index processor 150, upon reading the data values in the first flag data field 414a determines that the data stored in the data section 416 of the first sub-buffer 410a is a portion of a key frame and proceeds to the subsequent second sub-buffer 410b to determine if that sub-buffer stores the remaining portion of the key frame or if there are further sub-buffers that include data associated with this key frame. Upon parsing the flag data field 414b in the second sub-buffer 410b, the index processor 150 identifies that the data stored in data section 416b completes the key frame that was initially stored in the first sub-buffer 414a and updates the index file to include the addresses of these sub-buffers identifying this key frame and its position relative to the start of the entire stream to the index file. This enables the apparatus to quickly jump to the data stored in these sub-buffers when trick mode playback is initiated by a user.

FIG. 4C depicts an embodiment of the present principles in which the demux 130 determines that a key frame, K1, =3. This means that the current key frame, based on the analysis of available space in a previous and current sub-buffer, is identified by the demux 130 as existing in three sub-buffers 420a, 420b and 420c. Thus, together, sub-buffers 420a, 420b and 420c include a complete key frame (K1) stored in the data section 426a, 426b and 426c, respectively. The demux 130, when parsing the stream, determines that this particular key frame has a size that requires it be partitioned into a first portion, K1A, for storage in a first sub-buffer 420a, a second portion, K1B, for storage in a second sub-buffer 420b and a third portion, K1C, for storage in a third sub-buffer 420c. Because this key frame spans three sub-buffers 420a-420c, the flag data stored in flag data field 424a of the first sub-buffer 420a is the second type of flag data described above wherein the first sub-field representing the start position is indicated as “true” and stored in binary as a “1” and the second sub-field is indicated as “false” and stored, in binary as “0”. Because there are three sub-buffers required, the flag data stored in the flag data field 424b is the fourth type of flag data described above wherein the first sub-field representing the start position and the second sub-field representing the end position are both indicated as “false” and stored in binary, as “(0,0)”. The flag data stored in flag data field 424c is the third type of flag data described above wherein the first sub-field representing the start position is indicated as “false” and stored in binary as a “0” and the second sub-field is indicated as “true” and stored in binary as “1”. Having a sub-buffer with flag data of the fourth type (“0,0”) between sub-buffers having flag data of the second type and third type, respectively, indicates to the index processor 150 that the present key frame spans three sub-buffers. The index processor 150, upon reading the data values in the first flag data field 424a, determines that the data stored in the data section 416 of the first sub-buffer 420a is a portion of a key frame and proceeds to the subsequent second sub-buffer 420b to determine if that sub-buffer stores the remaining portion of the key frame or if there are further sub-buffers that include data associated with this key frame. As indicated above, the flag data of the second sub-buffer 420b being of the fourth type indicates that it is a portion of the key frame and that there are further sub-buffers downstream that include other portions of the key frame. Thereafter, the index processor 150 parses the flag data field 424c in the third sub-buffer 420c and identifies that the data stored in data section 426c completes the key frame that began in the first sub-buffer 424a and continued into the second sub-buffer 420b. The index file generated by the index processor 150 is updated to include the addresses of these sub-buffers identifying this key frame and its position relative to the start of the entire stream to the index file. This enables the apparatus to quickly jump to the data stored in these sub-buffers when trick mode playback is initiated by a user.

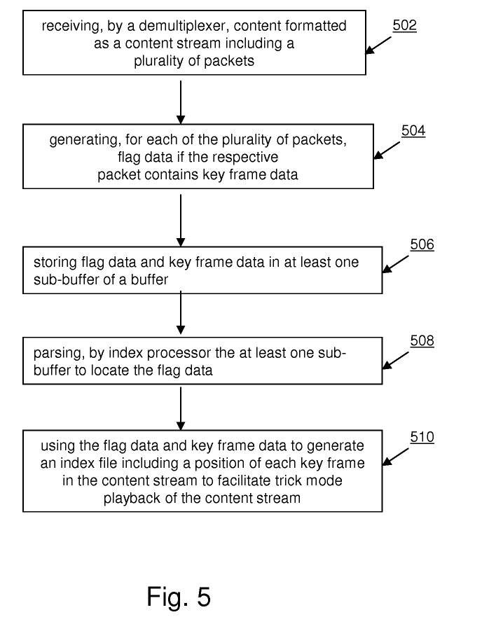

FIG. 5 depicts a flow diagram of a method in an apparatus for generating a recording index in accordance with an embodiment of the present principles. In operation, an apparatus of the present principles generates an index file that can be used during trick mode playback of a particular transport data stream. The method 500 begins at step 502 during which the demultiplexer receives content formatted as a transport stream including a plurality of transport packets from a source. The method 500 then proceeds to step 504.

At step 504, the demultiplexer generates, for each of the plurality of transport packets, flag data if the respective transport packet contains key frame data. The flag data can include a first sub-field associated with a start position of a key frame and a second sub-field associated with an end position of the key frame. In one embodiment of step 504, the generation of flag data may include determining that key frame data is to be stored in a single sub-buffer, setting a data value in the first sub-field as true and setting a data value in the second sub-field as true thereby identifying start and end positions, respectively, for the key frame data within the single sub-buffer.

In an alternate embodiment, step 504 can include determining that the data stored in a respective sub-buffer includes only a start position of a key frame and setting a data value in the first sub-field as true and setting a data value in the second sub-field as false thereby identifying a start position for the respective key frame and indicating that an end position of the respective key frame is located in a further sub-buffer.

In yet an alternate embodiment, step 504 can include determining that the data stored in a respective sub-buffer includes only an end position of a key frame, setting a data value in the first sub-field as false, setting a data value in the second sub-field as true thereby identifying an end position of for the key frame and indicating that a start position of the respective key frame is located in a further sub-buffer.

In an alternate embodiment, step 504 can also include determining that the data stored in a respective sub-buffer does not include a start position of end position, setting a data value in the first sub-field as false, setting a data value in the second sub-field as false thereby indicating that the sub-buffer includes a portion of a key frame having a start position in a first further sub-buffer and an end position in second further sub-buffer.

In a further embodiment, step 504 can include determining that the data stored in a respective sub-buffer does not include a start position of end position and a further buffer storing upstream transport stream data does not include a start position and identifying the data stored in the respective sub-buffer as a delta frame. If the demultiplexer of the apparatus determines that the data in the transport packet is a delta frame flag data is generated identifying the frame as a delta frame and the delta frame data is stored in a respective sub-buffer. However, the index processor automatically excludes the transport packet stored in the respective sub-buffer indicated as being delta frame data from the index file.

It should be noted that, the descriptions of the various embodiments described above are not mutually exclusive and the apparatus can implement any or all of the embodiments during the course of processing the transport stream and generating the index file. The method 500 then proceeds to step 506.

At step 506, the flag data and key frame data is stored in at least one sub-buffer of a buffer. The method 500 then proceeds to step 508.

At step 508, an index processor parses the at least one sub-buffer to locate the flag data and uses the flag data to generate an index file including a position of each key frame in the transport stream to facilitate trick mode playback of the transport stream. The method 500 can then be exited.

In one embodiment, the demultiplexer determines a number of sub-buffers needed to store the key frame data and the index processor generates the index file by using flag data from the determined number of sub-buffers. In an alternate embodiment, the index processor parses the transport stream to generate auxiliary data describing at least one characteristic of the transport stream and uses the flag data and the auxiliary data to generate the index file. In embodiments of the present principles, the at least one characteristic of the transport stream can include at least one of (a) offset information identifying a distance from a start position of the transport stream at which a respective key frame is positioned; (b) discontinuity information identifying one of a time gap between segments that comprise the transport stream; and (c) timestamp data for each transport packet in the transport stream.

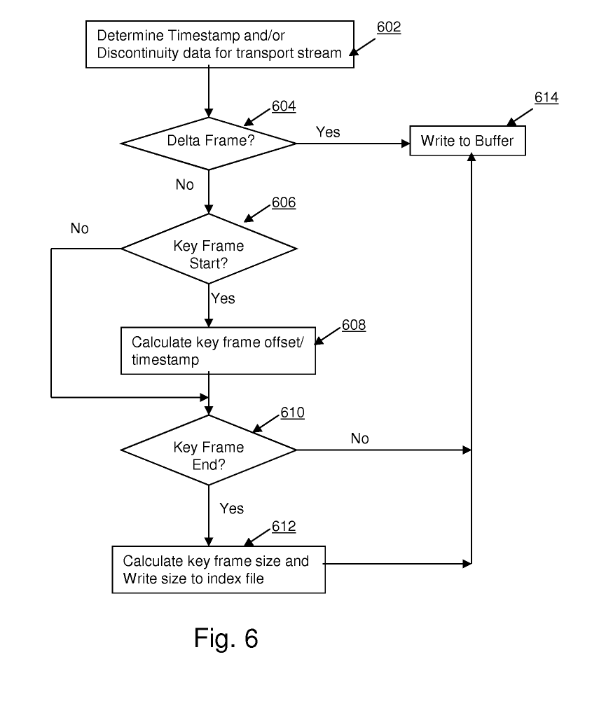

FIG. 6 depicts a flow diagram of a method for generating an index file which can be implemented in the method of FIG. 5 in accordance with an embodiment of the present principles. That is, FIG. 6 is a flow diagram detailing a method implemented by the index processor 150 of FIG. 1 for use in generating a common structure index file used in executing trick mode playback on an apparatus in accordance with an embodiment of the present principles. The following method is applied to each packet of a particular transport stream to identify and flag the type of frame contained in the packet. In the described embodiment, the method of FIG. 6 operates sequentially on the stream as it is being processed by the demux 130 and output to the index processor 150. Moreover, the method can be applied in real-time as a transport stream is being decoded for viewing by the user or, alternatively can be executed on a transport stream that has been stored as one or more files on a storage medium (e.g. previously recorded program) of an apparatus.

The method 600 begins at step 602 during which the index processor 150 determines auxiliary data associated with the transport stream including time stamp data and any discontinuity data associated therewith. The method 600 then proceeds to step 604.

At step 604, the index processor 150 queries whether the current frame is a delta frame. In one embodiment of the present principles, the query of step 604 can be implemented by parsing the flag data in the flag data field of the buffer in which the packet was stored by the demux 130 and comparing the flag data in the flag data field to the flag data in the flag data field of the previous transport packet. If this comparison results in the fourth type of flag data indicating that the packet has no start position indicator or end position indicator, the index processor determines the flag data of the previous packet. If the flag data of the previous packet includes the first type of flag data, the third type of flag data or the fourth type of flag data, the index processor determines that the frame in the current packet is a delta frame, the algorithm determines that the frame is a delta frame and proceeds to step 614. If the comparison in step 604 results in the flag data of the previous frame being the second type of flag data, the index processor determines that the current frame is not a delta frame and the method 600 proceeds to step 606.

At step 606, the index processor determines if the current frame is the start of a key frame by parsing the sub-fields of the flag data associated with the current frame. If the first sub-field includes a “true” value indicating that the flag data is either the first type of flag data or second type of data, the result of the query of step 606 is positive. The method 600 then proceeds to step 608. If the query determines that the current frame is not the start of the key frame by identifying that the first sub-field in the flag data is “false”, the method 600 proceeds to step 610 where the index processor determines if the current frame is an end of a key frame.

At step 608, the index processor calculates the key frame offset and time stamp using the auxiliary data identified in step 602. The method 600 then proceeds to step 610.

At step 610, the index processor further determines if the current frame also includes an end position by parsing the second sub-field of the flag data associated with the current frame. If the second sub-field value is also “true”, the index processor determines that the current frame includes the end of a particular key frame. The method 600 then proceeds to step 612. If the determination in step 610 is negative because the second sub-field of the flag data includes a “false” value, the method proceeds to step 614.

At step 612, the index processor calculates the key frame size by determining a number of sub-buffers that contain data associated with the key frame generation (or, if already generated, updating an index file with the size, position, and offset of the key frame for later access during trick mode). The method 600 then proceeds to step 614.

At step 614, the index file or data packet (frame) is written to the buffer (or other storage medium). The method 600 can then be exited.

Table 2 below depicts an embodiment of the type of data that can exist in a particular transport packet of a transport stream in accordance with an embodiment of the present principles.

| Case # | Sub-Field 1 | Sub-Field 2 | Type of Data in Buffer |
|---|---|---|---|
| 1 | True | True | Complete Key Frame |
| 2 | True | False | Start of Key Frame, |
| | | | multiple buffers |
| 3 | False | True | End of Key Frame, |
| | | | multiple buffers |
| 4 | False | False | Either part of key |
| | | | frame or delta frame |

In the event that the index processor determines that current transport packet includes a frame corresponding to either Case 1 or Case 3, the index processor then moves onto the subsequent packet in the stream. In response to the index processor determining that the current transport packet includes a frame corresponding to Case 2, the index processor marks the beginning of the key frame and analyzes subsequent transport packets to determine if the next transport packet in the stream corresponds to either Case 3 or Case 4. If the next packet in the stream corresponds to Case 3, the index processor identifies that the key frame spans two sub-buffers and updates the index file accordingly with position and size information associated with the key frame and then analyzes the next transport packet in the stream. If, after determining that the current transport packet corresponds to Case 2, the index processor determines that the next transport packet corresponds to Case 4, the index processor identifies that the key frame spans two or more sub-buffers and continues to analyze subsequent transport packets until a particular subsequent transport packet corresponds to Case 2. Thereafter, index processor determines the total number of sub-buffers having information associated with the particular key frame and updates the index file accordingly. In response to identifying that the transport packet corresponds to Case 4, the index processor identifies the state of the immediately preceding transport packet. If the immediately preceding transport packet corresponds to either Case 1 or Case 3, the index processor flags the current frame as a delta frame and writes the value to its buffer but does not update the index file. If the immediately preceding transport packet corresponds to Case 2, the index processor identifies the frame of the current transport packet as a portion of a key frame and then looks to the subsequent transport packets to determine the end position of the key frame. If the immediately preceding transport packet corresponds to Case 4, the index processor looks to prior transport packets to determine if any prior transport packets correspond to Case 2. If this is true, then the current frame is identified as part of a key frame spanning multiple sub-buffers. If the analysis of the prior transport packets indicates either Case 1 or Case 3, then the frame in the current transport packet is identified as a delta frame and its value is written to the buffer but the index file is not updated.

Having described various embodiments of a method and apparatus for indexing data streams and generating an index file (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present principles, other and further embodiments of the invention may be devised without departing from the basic scope thereof.

We claim:

1. An apparatus for indexing a data stream, comprising:
a demultiplexer that receives a content stream including a plurality of packets and generates flag data for the plurality of packets if a respective packet contains key frame data,
a buffer including at least one sub-buffer for storing the flag data and key frame data; and
an index processor that parses the at least one sub-buffer to locate the flag data and uses the flag data and the key frame data to generate an index file including a position of each key frame in the content stream to facilitate trick mode playback of the content stream.

2. The apparatus according to claim 1, wherein
the demultiplexer determines a number of sub-buffers needed to store the key frame data, wherein the generated flag data indicates the number of sub-buffers needed to store the key frame data.

3. The apparatus according to claim 2, wherein
the index file is generated by the index processor using flag data from the determined number of sub-buffers.

4. The apparatus according to claim 1, wherein
the index processor parses the content stream to generate auxiliary data describing at least one characteristic of the content stream and the index file is generated using the flag data and the auxiliary data.

5. The apparatus according to claim 4, wherein
the at least one characteristic of the content stream includes at least one of (a) offset information identifying a distance from a start position of the content stream at which a respective key frame is positioned; (b) discontinuity information identifying one of a time gap between segments that comprise the content stream; and (c) timestamp data for each packet in the content stream.

6. The apparatus according to claim 1, wherein
the flag data includes a first sub-field associated with a start position of a key frame and a second sub-field associated with an end position of the key frame.

7. The apparatus according to claim 6, wherein
upon determining that key frame data is to be stored in a single sub-buffer, a data value in the first sub-field is set as true and a data value in the second sub-field is set as true identifying start and end positions, respectively, for the key frame data within the single sub-buffer.

8. The apparatus according to claim 6, wherein
upon determining that the data stored in a respective sub-buffer includes only a start position of a key frame, a data value in the first sub-field is set as true and a data value in the second sub-field is set as false, identifying a start position for the respective key frame and indicating that an end position of the respective key frame is located in a different sub-buffer.

9. The apparatus according to claim 8, wherein
upon determining that the data stored in a respective sub-buffer includes only an end position of a key frame, a data value in the first sub-field is set as false and a data value in the second sub-field is set as true, identifying an end position for the key frame and indicating that a start position of the respective key frame is located in a different sub-buffer.

10. The apparatus according to claim 9, wherein
upon determining that the data stored in a respective sub-buffer does not include a start position or an end position of a key frame, a data value in the first sub-field is set as false and a data value in the second sub-field is set as false indicating that the sub-buffer includes a portion of a key frame having a start position in a first different sub-buffer and an end position in second different sub-buffer.

11. The apparatus according to claim 6, wherein
upon determining that the data stored in a respective sub-buffer does not include a start position or an end position of a key frame and that a different buffer storing upstream content stream data does not include a start position, the data stored in the respective sub-buffer is identified as a delta frame.

12. The apparatus according to claim 1, wherein the content stream comprises a transport stream and the packets comprise transport packets.

13. A method for indexing a data stream, comprising:
receiving, by a demultiplexer, a content stream including a plurality of packets;
generating flag data, for the plurality of packets if the respective packet contains key frame data;
storing flag data and key frame data in at least one sub-buffer of a buffer;
parsing the at least one sub-buffer to locate the flag data; and
using the flag data and key frame data to generate an index file including a position of each key frame in the content stream to facilitate trick mode playback of the content stream.

14. The method according to claim 13, further comprising
determining, by the demultiplexer, a number of sub-buffers needed to store the key frame data, wherein the generated flag data indicates the number of sub-buffers needed to store the key frame data.

15. The method according to claim 14, wherein the index file is generated using flag data from the determined number of sub-buffers.

16. The method according to claim 13, further comprising
parsing the content stream to generate auxiliary data describing at least one characteristic of the content stream; and
using the flag data and the auxiliary data to generate the index file.

17. The method according to claim 16, wherein
the at least one characteristic of the content stream includes at least one of offset information identifying a distance from a start position of the content stream at which a respective key frame is positioned, discontinuity information identifying one of a time gap between segments that comprise the content stream and timestamp data for each packet in the content stream.

18. The method according to claim 13, wherein
the flag data includes a first sub-field associated with a start position of a key frame and a second sub-field associated with an end position of the key frame.

19. The method according to claim 18, further comprising
determining that key frame data is to be stored in a single sub-buffer;
setting a data value in the first sub-field as true;
setting a data value in the second sub-field as true; and
identifying start and end positions, respectively, for the key frame data within the single sub-buffer.

20. The method according to claim 18, further comprising
determining that the data stored in a respective sub-buffer includes only a start position of a key frame;
setting a data value in the first sub-field as true;
setting a data value in the second sub-field as false; and
identifying a start position for the respective key frame and indicating that an end position of the respective key frame is located in a different sub-buffer.

21. The method according to claim 20, further comprising
determining that the data stored in a respective sub-buffer includes only an end position of a key frame;
setting a data value in the first sub-field as false;
setting a data value in the second sub-field as true; and
identifying an end position of for the key frame and indicating that a start position of the respective key frame is located in a different sub-buffer.

22. The method according to claim 21, further comprising
determining that the data stored in a respective sub-buffer does not include a start position or end position of a key frame;
setting a data value in the first sub-field as false;
setting a data value in the second sub-field as false; and
indicating that the sub-buffer includes a portion of a key frame having a start position in a first different sub-buffer and an end position in a second different sub-buffer.

23. The method according to claim 18, further comprising
determining that the data stored in a respective sub-buffer does not include a start position or end position of a key frame and a different buffer storing upstream content stream data does not include a start position; and
identifying the data stored in the respective sub-buffer as a delta frame.

24. The method according to claim 13, wherein said content stream comprises one of a live content stream and a pre-recorded content stream.

25. The method according to claim 13, further comprising
determining, by the demultiplexer, if a packet comprises delta frame data;
storing the delta frame data in a respective sub-buffer; and
excluding the packet stored in the respective sub-buffer determined as being delta frame data from the index file.

26. A method for generating an index file of a content stream, comprising:
determining auxiliary data associated with each packet of the content stream including at least one of time stamp data and discontinuity data associated with each packet;
for each packet of the content stream determining if a current packet comprises a delta frame;
if a current packet comprises a delta frame, storing the delta frame data in a respective sub-buffer; and
if a current packet does not comprise a delta frame, for each packet of the content stream;
determining start and end positions of a key frame in the packet;
determining a key frame offset and time stamp of the key frame in the packet;
determining a key frame size of the key frame in the packet; and
storing key frame data in a respective sub-buffer.
